(19) United States
(12) Patent Application Publication
(10) Pub. No.: US 2010/0132451 A1
(43) Pub. Date: Jun. 3, 2010

(54) METHOD AND DEVICE FOR DETERMINING VOLUME DURING TRANSFER OF A LIQUID

(76) Inventors: Alfred Böhm, Viechtach (DE); Wilhelm Binder, Tiefenbach (DE); Dieter Lerach, Zwiesel (DE)

Correspondence Address: JACOBSON HOLMAN PLLC, 400 SEVENTH STREET N.W., SUITE 600, WASHINGTON, DC, 20004, US

(21) Appl. No.: 12/598,997

(22) PCT Filed: May 22, 2007
(86) PCT No.: PCT/EP07/04535

§ 371 Date: Nov. 5, 2009

(51) Int. Cl. G01F 15/08; G01F 23/00

(52) U.S. Cl. 73/200; 73/290 R

(57) ABSTRACT

The invention relates to a method for determining an amount during the transfer of a liquid, wherein the liquid is introduced at a supply opening into a measurement line and is removed from the measurement line at an outlet opening, and an amount of liquid flowing through the measurement line is determined by means of a flow measuring unit assigned to the measurement line. According to the invention, liquid present in the measurement line is discontinuously fed to a degassing arrangement. The invention further relates to a device for determining an amount during the transfer of a liquid.

### CROSS-REFERENCE TO RELATED APPLICATIONS

The present patent application is a nationalization of International application No. PCT/EP2007/004535, filed May 22, 2007, published in German, which is incorporated herein by reference in its entirety.

### BACKGROUND OF THE INVENTION

1. Field of the Invention

The invention relates to a method for determining an amount during transfer of a liquid, in particular milk, wherein the liquid is introduced at a supply opening into a measurement line and is removed from the measurement line (30) at an outlet opening, and an amount of liquid flowing through the measurement line is determined by means of a flow measuring unit assigned to the measurement line. It is provided in such a method that the liquid is introduced at a supply opening into a measurement line and is removed at an outlet opening from the measurement line, and the amount of liquid flowing through the measurement line is determined by means of a flow measuring unit assigned to the measurement line.

The invention further relates to a device for determining an amount during transfer of a liquid, in particular for carrying out the method according to the invention, with a measurement line which comprises at one of its ends a supply opening and at its other end an outlet opening for the liquid and with a flow measuring unit assigned to the measurement line for measuring the amount of liquid flowing through the measurement line.

2. Related Art

A generic method and a generic device are known for example from EP 0 855 576 A1. This document teaches that a flow meter for determining an amount can be provided in the discharge line of a tank. In order to prevent the measurement result of the meter being falsified as a result of gas pockets which may be contained under certain conditions in the liquid flow, according to EP 0 855 576 A1 a degassing container is provided in the discharge line upstream of the meter, which can also be described as a gas separator. The gas separator serves to separate possibly present gas portions from the flow before it reaches the meter and to return them to the tank.

Such a gas separator for use in a milk collecting installation is known for example from DE 296 23 713 U1. In order to be able to draw in milk via a suction line when using this known gas separator, according to DE 296 23 713 U1 a vacuum pump is provided on the gas separator, with which the gas separation container can be placed under underpressure, so that milk is sucked into the container via the suction line. A foam collecting container is provided between the vacuum pump and the gas separator according to DE 296 23 713 U1 and this is intended to prevent foam, which forms when the milk is sucked in, from reaching the vacuum pump and impairing its functionality under certain conditions.

The gas separators known from the prior art have, however, a relatively large volume, which is determined by the flow quantity per time unit, thus the intake capacity. In particular, the necessary gas separator volume increases with increasing intake capacity. In practice, therefore, it is necessary to either limit the intake capacity or to select a comparatively heavy and voluminous air separator, whereby this is undesirable in particular with tanker vehicles.

A measurement method has thus been developed, wherein a liquid amount determination is possible with reduced air separator volume. A method is thus known from DE 197 10 296 C1 wherein only a part of the milk flow is degassed. The remaining main flow on the other hand is not degassed. An ultrasound measurement is carried out in both flows, by means of which conclusions can be drawn in relation to the gas load and thus the milk volume flow.

A method for determining the amount conveyed is known from DE 10 2005 005 295 A1, wherein gas portions are not separated and are instead detected by means of a unit for measuring the degree of filling and included in the calculation of the amount conveyed. However, this method makes comparatively high demands upon the precision of the unit for measuring the degree of filling.

### SUMMARY OF THE INVENTION

It is an object of the invention to indicate a method and a device for determining an amount which facilitate a reliable and exact determination of an amount while having a particularly compact installation structure and high delivery rates through the measurement line.

The object is achieved through a method for determining an amount during the transfer of a liquid, in particular milk, wherein the liquid is introduced at a supply opening into a measurement line and is removed from the measurement line at an outlet opening, and the amount of liquid flowing through the measurement line is determined by means of a flow measuring unit assigned to the measurement line, whereby a degassing arrangement is provided for the degassing of the liquid flowing in the measurement line before it reaches the flow measuring unit, and wherein, liquid present in the measurement line is discontinuously fed to the degassing arrangement so that the degassing arrangement is bypassed at times; and a device for determining an amount during the transfer of a liquid, having a measurement line which comprises a supply opening at one of its ends and an outlet opening for the liquid at the other end, and a flow measuring unit assigned to the measurement line for measuring the amount of liquid flowing through the measurement line, wherein an intermediate storage unit is provided which branches from the measurement line between the supply opening and the flow measuring unit, in particular in a pipeline region of the measurement line, and a unit for generating an underpressure in the intermediate storage unit is provided, by means of which a liquid volume can be conveyed from the measurement line into the intermediate storage unit.

The method according to the invention is characterized in that liquid present in the measurement line is discontinuously supplied to a degassing arrangement.

The invention is based upon the recognition that significant gas pockets frequently occur only at certain times during the transfer of a liquid and indeed in particular at the start of the transfer process, on account of the still incomplete suction process, and/or at the end of the transfer process, on account of the emptying through suction of the hose system. Besides, extraordinary gas flows can also arise which are generated for example by leaking couplings, defective hoses or deliberate tampering.

Particularly with larger transfer amounts, wherein the start and end processes fade into the background, there are thus frequently no notable gas pockets during the longest period of the transfer process. During most of the time during the transfer process no gas separation is thus necessary due to the absence of notable gas pockets.

This is met by the invention in that during normal operation, if therefore no notable gas load is present, the liquid flow is fed past the degassing arrangement. Since according to the invention at this stage the liquid does not have to flow through the degassing arrangement, the degassing arrangement does not limit the delivery speed at this stage. Therefore, particularly high delivery rates can be achieved. In addition, the degassing arrangement can also have a particularly simple and compact structure, as it is generally not affected by the majority of the total volume of liquid delivered.

It is merely when notable gas portions arise in the liquid, thus for example at the beginning of the transfer, at the end of the transfer and in case of malfunctions, that according to the invention liquid which flows through the cross-section of the measurement line is fed to the degassing arrangement and thus a targeted degassing is carried out. According to the invention degassing is thus carried out only on a time-related basis, thus sporadically. Consequently only a time-related fraction of the liquid flowing through the measurement line is subjected to degassing.

The invention thus allows the gas pockets occurring regularly at the beginning and/or at the end of the transfer but also allows extraordinary gas flows, which are produced for example by leaking couplings, defective hoses or deliberate tampering, to be considered and a correct determination of an amount to be guaranteed in spite of these gas flows at certain times. On the other hand particularly high delivery rates are achieved according to the invention as the degassing arrangement is bypassed in normal operation.

The liquid can be in particular milk and in case of the gas, for the separation of which the degassing arrangement is provided, this can be air. The invention is particularly suited to receive liquid, in particular in a tanker vehicle. The invention can, however, also be used during the liquid discharge. The flow measuring unit which can for example be a turbine meter or a magneto-inductive measuring unit is preferably arranged on the measurement line. The degassing arrangement can be formed in particular as a stilling basin.

The liquid flowing through the measurement line is appropriately fed to the degassing arrangement if a certain precondition arises. This can for example be a time-related condition which allows in particular the start and/or the end of the transfer process to be deduced. It can for example be provided that liquid present in the measurement line is fed to the degassing arrangement at least at the beginning and/or at the end of the transfer. However, the condition can also be the exceeding of a previously determined gas portion in the liquid, whereby a removal of extraordinary gas flows is also possible. Alternatively or additionally, it can thus be provided that the gas portion of the liquid present in the measurement line is measured and that liquid present in the measurement line is fed to the degassing arrangement if a certain previously determined value for the gas portion is exceeded.

According to a particularly preferred embodiment of the invention a liquid volume is removed from the measurement line between the supply opening and the flow measuring unit and transferred for degassing into an intermediate storage unit, which branches from the measurement line between the supply opening and the flow measuring unit, in particular in a pipeline region of the measurement line. The removed liquid volume is then fed from the intermediate storage unit, in particular between the supply opening and the flow measuring unit, back into the measurement line. This can be regarded as an independent aspect of the invention.

According to this embodiment a separation of gas portions is not carried out—as in the manner of the prior art—through a gas separator arranged directly in the line progression of the measurement line. Instead the degassing arrangement, which is formed by the intermediate storage unit, is provided outside of the line progression of the measurement line at a branch of the measurement line. According to this embodiment the volume to be degassed is taken before its flow measurement into an intermediate storage unit branching off from the measurement line, where it is degassed and, after degassing, is fed back into the measurement line for flow measurement. It is preferably fed back at the same location at which the liquid volume was removed. The feedback can, however, also be carried out at a different location. The intermediate container appropriately branches from the measurement line in a pipeline region thereof, whereby this can be understood to mean any line region at which no gas separator is arranged.

It is particularly advantageous that the intermediate storage unit has a storage line which can be formed in particular as a pipeline. Such a storage line is particularly favorable in the production. In addition, a storage line can be housed in a particularly simple way on a measurement installation, in particular on a milk collecting vehicle.

In particular in order to facilitate the degassing of larger amounts, it is advantageous that a storage container is provided on the storage line.

In order to convey the liquid volume from the measurement line into the intermediate storage unit it can be provided for example that a pump unit provided on the measurement line is actuated and an overpressure is hereby created in relation to the intermediate storage unit. In relation to the speed of the process, however, it is particularly advantageous that for the removal of the liquid volume from the measurement line an underpressure is produced on the intermediate storage unit. In this connection for example an ejector, a water ring pump and/or a membrane pump can be provided. If the volume is generated with an ejector, this does not generally require a large volume. The ejector—compressed air unit can be heated insofar as this is necessary on account of the ambient temperature.

In order to convey the liquid volume back into the measurement line it can for example be provided that a gas is introduced into the intermediate storage unit. A particularly complete emptying of the storage unit can hereby be carried out.

Alternatively or additionally, it can be provided that a pump arranged on the measurement line is actuated in order to feed the liquid volume back into the measurement line. In this case it is possible to feed back the liquid volume using a particularly small amount of equipment resources.

It is further particularly useful that the intermediate storage unit is shut off by means of a valve arranged on the intermediate storage unit if the fill level in the intermediate storage unit falls below a certain value when the liquid volume is fed back. A situation can hereby be prevented in which during the feedback of the liquid into the measurement line gas is taken along from the intermediate storage unit into the measurement line.

According to a further preferred embodiment of the invention, when removing the liquid volume from the measurement line a fluid connection is shut off between the intermediate storage unit and the flow measuring unit. According to this embodiment it is possible to prevent, during the removal of liquid from the measurement line for the purpose of degassing, liquid being removed from the region of the flow measuring unit, whereby this could lead to incorrect measurements under certain circumstances.

Furthermore it is particularly advantageous that during the feedback of the liquid volume into the measurement line a fluid connection is shut off between the supply opening and the intermediate storage unit. A particularly good delivery rate is hereby maintained.

It is further useful that during the feedback of the liquid volume into the measurement line a flow cross-section of the measurement line is reduced, in particular through a valve arranged downstream of the flow measuring unit. An additional flow resistance is hereby created which reduces the flow speed during return of the liquid volume. As the liquid volume removed into the intermediate storage unit for degassing is generally comparatively small, the storage unit is hereby prevented from being emptied too quickly and possibly in an uncontrolled manner, whereby this could go hand in hand with the entry of gas portions from the intermediate storage unit into the measurement line. In addition, due to the pressure increase associated with the flow resistance, the volume of possibly present gas bubbles is reduced.

According to a further preferred embodiment of the invention a pressure is measured in the measurement line and the pump arranged on the measurement line is controlled in dependence upon the measured pressure. The pressure is hereby appropriately a suction pressure which is measured upstream of the pump. In particular the pump can be controlled in such a way that the suction pressure is regulated to a value at which cavitation of the liquid is suppressed. According to this embodiment the pump system can be self-adapting so that its delivery rate reliably remains below the cavitation threshold. Since according to the invention no air separator is necessary in the progression of the measurement line which could bring pressure drops with it, it is possible according to the invention for the pressure at the supply opening, that is to say at the entry to the system, to be controlled in a particularly simple way, in particular through a closed-loop control.

In order to further increase the measurement precision it is advantageous that a gas portion of the liquid present in the measurement line is determined and that the measured gas portion is used to compensate measurement values of the flow measuring unit. This embodiment allows remaining gas amounts, which arise under certain conditions in spite of degassing measures, to be included in the measurement and to be taken into consideration in the determination of the amount of the liquid. Furthermore, this embodiment allows gas portions to be tolerated below a threshold value before degassing has to be started.

Having regard to the delivery speed and the reliability of the method according to the invention it is further advantageous that a gas portion of the liquid present in the measurement line is determined and that the pump arranged on the measurement line is controlled, in particular through closed-loop control, in dependence upon the measured gas portion. It is hereby possible to prevent an excessive gas portion from being prematurely sucked into the measurement line, due to pumping power that is too high, in particular at the end of the transfer. In turn, this allows the time at which degassing is necessary through transfer of liquid into the intermediate storage unit to be delayed and thus the liquid volume involved in the degassing can be reduced.

In order to measure the gas portion in the measurement line a degree of filling sensor is appropriately provided which can also be described as a bubble sensor.

The device according to the invention is preferably adapted to carry out the method according to the invention, whereby the advantages explained in this connection can be achieved. According to the invention the features explained in association with the method can also be used in connection with the device. At the same time the features explained in connection with the device can be used in the method.

A generic device which comprises a degassing unit for the liquid, which is assigned to the measurement line, can also be further developed according to the invention in that means are provided with which a liquid exchange between the degassing unit and the measurement line can be shut off This enables a liquid exchange between the measurement line and the degassing unit to only be allowed at certain times and thus the implementing of a time-related, discontinuous degassing of the liquid flowing through the measurement line.

In particular a device according to the invention is characterized in that an intermediate storage unit is provided which branches from the measurement line between the supply opening and the flow measuring unit, in particular in a pipeline region of the measurement line, and in that a unit for generating an underpressure in the intermediate storage unit is provided, by means of which a liquid volume can be transferred from the measurement line into the intermediate storage unit.

A particularly simple feeding of the liquid back into the measurement line is facilitated according to the invention in that on the intermediate storage unit a vent unit is provided, by means of which a gas can be introduced into the intermediate storage unit for the purpose of returning the liquid volume from the intermediate storage unit into the measurement line. The gas can in particular be air.

Having regard to the apparatus costs it is particularly advantageous that the intermediate storage unit comprises a storage line which can be produced in a particularly simple way. For the purpose of increasing the volume a storage container is preferably provided on the storage line.

According to a further preferred embodiment of the invention, which can bring with it a time saving in the transfer, a plurality of vent units are arranged along the intermediate storage unit and a shut-off valve is arranged between each of the individual vent units on the intermediate storage unit. This allows the intermediate storage unit to be emptied in stages. As soon as the fill level reaches a shut-off valve, this can be closed and the remaining intermediate storage unit region can be emptied by actuating the next vent unit facing the measurement line. The rear region of the shut-off valve can thereby already be evacuated again, so that a sufficient underpressure is available particularly quickly for feeding a further liquid volume into the intermediate storage unit.

The reliability of the device according to the invention can be further improved in that at least one fill level sensor is provided on the intermediate storage unit, in particular on the storage container. It is hereby possible to monitor the liquid transfer process in the intermediate storage unit.

Insofar as a fill level sensor is provided on the intermediate storage unit it is particularly advantageous that a valve, in particular a shut-off valve, is provided between the unit for generating the underpressure and the collecting line, whereby said valve can be actuated in dependence upon the fill level determined by the fill level sensor. With such an arrangement it is possible to prevent, in case of an excessive increase in the fill level in the intermediate storage unit, liquid from reaching the unit for generating the underpressure and impairing its functionality.

It is advantageous for particularly high delivery rates that a pump is provided on the measurement line. The pump is appropriately arranged between the branch of the intermediate storage unit and the outlet opening in the measurement line. In this case the pump allows both delivery of the liquid in normal operation and also emptying of the intermediate storage unit after degassing.

It is particularly advantageous that a purge line is provided on the pump, which purge line preferably runs into the intermediate storage unit. This allows gas portions to be removed which may collect under certain conditions in the upper region of the pump and can influence the performance of the pump and the measurement precision as well as leading under certain conditions to cavitation, which can be detrimental to the quality of milk conveyed.

It is further useful according to the invention for the height of the measurement line in the region between the supply opening and the intermediate storage unit to decrease at least in areas towards the intermediate storage unit. This allows a particularly efficient emptying of the input-side line system at the end of the discharge to be achieved, as residual liquid present on the inlet side flows independently towards the intermediate storage unit on account of gravitational force. Furthermore, an automatic degassing function can be made available, in which gas portions flow back towards the supply opening.

It is furthermore advantageous according to the invention that a tank is arranged on the measurement line in the region of the outlet opening and/or that a connection unit for a suction hose is arranged on the measurement line in the region of the supply opening. In particular the device can be arranged together with the tank on a tanker vehicle. The suction hose can appropriately be provided for emptying milk containers.

It is furthermore useful that the measurement line is formed on the side of the intermediate storage unit facing away from the supply opening to be U-shaped, in particular being double U-shaped. The U shape is thereby appropriately formed in at least one vertically extending plane. The pump is preferably arranged in the region of an apex of the U shape. The apex of the U-shaped structure is usefully arranged below the branch of the intermediate storage unit. An automatic purge function can hereby also be made available downstream of the intermediate storage unit, in which gas portions flow independently into the intermediate storage unit on account of their buoyancy.

According to a particularly preferred development of the device according to the invention a control unit is further provided which is adapted to carry out the method according to one of the preceding claims.

With the device according to the invention a measurement installation for milk collecting vehicles can be created, the receiving or acceptance capacity of which is in many cases only limited by the local factors. By omitting a gas separator, regulation can take place directly on the underpressure at the system entry, whereby the pump system can adapt itself and always remain reliably below the cavitation threshold in its delivery power.

The vacuum supply container formed on the intermediate storage unit facilitates at the end of the acceptance stage particularly efficient emptying of the supplier tank and the acceptance hose through suction.

It has been shown that with the installation according to the invention milk can be sucked away from a 4.5 m deep acceptance tank, whereby the residual amount remaining in the hose is not greater than if the acceptance stage were carried out on level ground. By measuring the air pockets in the milk received the measurement precision is increased. At the same time tampering and reduction of the liquid acceptance rate are counteracted.

### BRIEF DESCRIPTION OF THE DRAWINGS

The invention is explained in greater detail below by reference to preferred embodiments which are shown schematically in the drawings, in which:

FIG. 1 shows a greatly schematized view of a device according to the invention for implementing the method according to the invention;

FIG. 2 shows a detailed view of the device of FIG. 1;

FIGS. 3 and 4 show the device of FIG. 2 in different method stages during implementation of the method according to the invention;

FIG. 5 a further embodiment of a device according to the invention for implementing the method according to the invention;

FIG. 6 a further embodiment of a device according to the invention for implementing the method according to the invention; and

FIG. 7 a perspective detailed view of the devices of FIGS. 2 to 6 in the line region downstream of the intermediate storage unit.

Elements having the same effect are designated in the drawings by the same reference numerals.

### DETAILED DESCRIPTION OF THE PREFERRED EMBODIMENTS

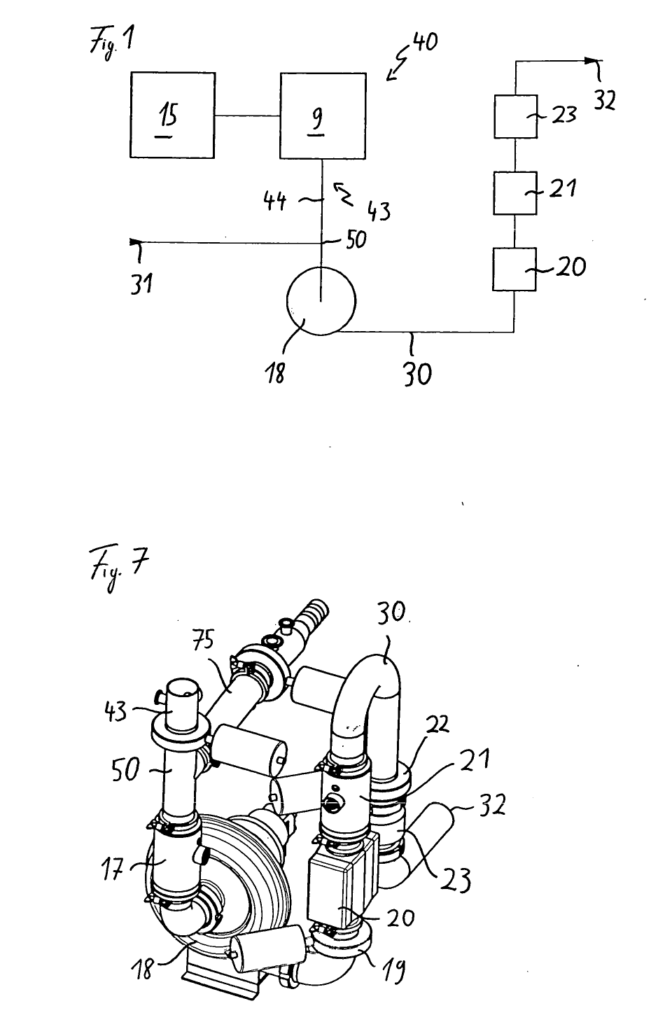

A first embodiment of a device according to the invention is shown in FIG. 1. The device comprises a measurement line 30 which extends between a supply opening 31 and an outlet opening 32. A pump 18 is arranged in the measurement line 30 and serves for active delivery of liquid through the measurement line 30. On the side of the pump 18 facing the outlet opening 32 a flow measuring unit 20 for detecting the amount of liquid flowing through the measurement line 30 is provided in the measurement line 30. A gas portion measuring unit 21 and a non-return valve 23 connect to said flow measuring unit 20 in the flow direction, that is to say towards the outlet opening 32.

The device shown in FIG. 1 does not have a gas separator in the progression of the measurement line 30. For the purpose of degassing the liquid flowing in the measurement line 30 before reaching the flow measuring unit 20, a degassing arrangement 40 with an intermediate storage unit 43 is instead provided, which branches at a branch 50 upwards from the measurement line 30. This intermediate storage unit 43 comprises a storage line 44, on which a storage container 9 is arranged, which can also be described as a suction container. A unit 15 for generating an underpressure in the storage container 9 is arranged in turn on this storage container 9.

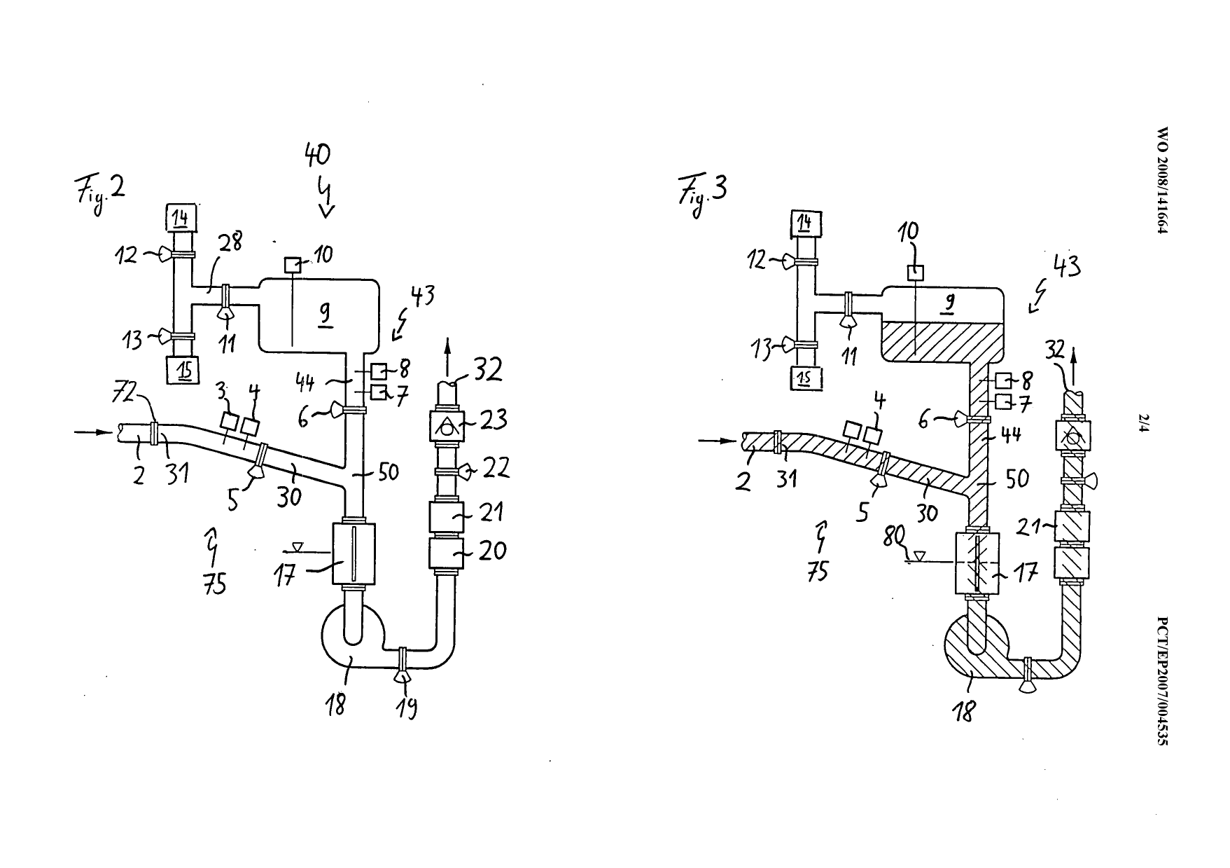

The device of FIG. 1 is shown in detail in FIG. 2. As shown in FIG. 2, a connection unit 72 is provided in the region of the supply opening 31 of the measurement line 30, on which connection unit 72 a suction hose 2 for milk is arranged, which allows milk to be taken from a supplier tank. Starting from the supply opening 31 in the progression of the measurement line 30 a sensor 3 is arranged which serves to detect liquid, in particular milk, and to measure the temperature in the measurement line 30. In the further progression of the measurement line 30 a pressure sensor 4 is provided, to which an inlet valve 5 formed as a shut-off valve connects. In the further progression of the measurement line 30 there is the branch 50, at which the storage line 44 of the degassing arrangement 40 branches from the measurement line 30. In the region 75 between the supply opening 31 and the branch 50, the measurement line 30 extends inclined against the horizontal, so that it decreases in height with decreasing distance from the branch 50.

Following the branch 50 the measurement line 30 extends essentially vertically downwards. In this line region a fill level sensor 17 is provided on the measurement line 30 and which can be formed in particular as a combined gas fill level sensor. The pump 18 connects hereto in the progression of the measurement line 30. Following the pump 18 the measurement line 30 extends essentially horizontally. In this horizontally extending region a further shut-off valve 19 is arranged in the measurement line 30.

Following the shut-off valve 19 the measurement line 30 extends essentially vertically upwards. In this line region the flow measuring unit 20 and the gas portion measuring unit 21 are arranged one after the other. Connecting hereto with decreasing distance from the outlet opening 32 is a further valve 22, which can be formed as a shut-off and/or reducing valve, and also the non-return valve 23. A tank formed as a vehicle tank can be provided in the region of the outlet opening 32 on the measurement line 30.

In the storage line 44, which runs into the measurement line 30 at the branch 50, a further shut-off valve 6 is provided. On the side of the shut-off valve 6 facing away from the branch 50 a liquid sensor 7, in particular a milk sensor, and a pressure sensor 8 are arranged at the storage line 44.

Connecting hereto, on the side of the shut-off valve 6 facing away from the branch 50, is the storage container 9, which can be described as a vacuum container.

A fill level sensor 10 is provided on the storage container 9 of the intermediate storage unit 43 of the degassing arrangement 40. In an upper region of the storage container 9 a gas line 28 runs into said storage container 9 for feeding gas into said storage container 9 and for emptying said storage container 9. A valve 11 formed as a shut-off valve is provided in this gas line 28. On the side of the valve 11 facing away from the storage container 9 the gas line 28 is in line connection via a shut-off valve 12 with a vent unit 14 and via a shut-off valve 13 with the unit 15 for generating an underpressure.

The device shown in FIG. 2 can be operated as follows:

Acceptance process

In order to explain the acceptance or filling process, reference is made to FIG. 3, whereby for the sake of simplicity it is initially assumed that the system is already filled up to the threshold level 80 in the region of the fill level sensor 17.

At the start of the acceptance the shut-off valve 12 is closed and thus a connection between the vent unit 14 and the storage container 9 is interrupted. The valves 5, 6, 11 and 13 arranged in the line progression between the supply opening 31 and the unit 15 for generating an underpressure are then opened. The unit 15 for generating an underpressure then sucks milk into the measurement line 30 via the supply opening 31 and via the branch 50 into the intermediate storage unit 43. The storage container 9 thereby preferably has such dimensions that, together with the storage line 44 and in particular with the inlet region 75 of the measurement line 30, it can receive the whole volume of the suction hose 2.

As soon as the liquid sensor 7 and/or the pressure sensor 8 detect/s liquid, in particular milk, the valves 11 and 13 are closed and thus the connection between the storage container 9 and the unit 15 for generating an underpressure is separated. On account of the remaining vacuum in the storage container 9, however, further liquid is drawn into the vacuum container 9. The fill level of the storage container 9 is thereby monitored by means of the fill level sensor 10. Insofar as there is impending overrunning of the storage container 9, corresponding counter measures are initiated.

On account of the line arrangement, in particular on account of the fact that the line height between the branch 50 and the storage container 9, the fill level sensor 17 and the storage container 9, and the pump 18 and the storage container 9 increases towards the storage container 9, the system degases itself, whereby gas portions are collected in the storage container 9. The end of the automatic degassing can for example be recognized in that the fill level sensor 17 detects a completely filled pipe.

The pump 18 is then started. The pump 18 builds up a pressure which is lower than that in the storage container 9. The liquid is thereby drawn from the container 9 back into the measurement line 30. As soon as the liquid sensor 7 displays that there is no wetting, thus an empty state, the shut-off valve 6 is closed, possibly with a previously determined, short time delay, and the storage container 9 is hereby separated from the measurement line 30. The storage container 9 can now be emptied again by opening the valves 11 and 13.

The pump 18 maintains the underpressure during the further acceptance process and conveys liquid from the suction hose 2 to the outlet opening 32, whereby the suction power of the pump 18 is regulated. A suction pressure is hereby used as the control value which is determined by the pressure sensor 4 in the inlet region 75 of the measurement line 30. Through such a control it is possible to ensure that the pump 18 itself adapts to the different acceptance factors, for example different line cross-sections, different line lengths, different tank levels, etc., and that the suction pressure remains in a value range, within which cavitation of the liquid is suppressed.

In case of malfunction, for example through tampering or leaks in the hose screw connections or the hoses, significant gas mixtures can arise in the liquid during the acceptance. These are detected by the fill level sensor 17 and possibly also by the gas portion measuring unit 21. As soon as the fill level sensor 17 and/or the gas portion measuring unit 21 detect(s) gas portions mixed in, the power of the pump 18 and hence the suction pressure can be reduced. In addition a malfunction message can be generated. If the gas pocket is not yet hereby eliminated, the gas mixture can be tolerated up to a certain level, and be taken into consideration in the determination of the amount by including the values of the gas portion measuring unit 21.

If a suction forms in the delivery tank, in which the suction hose 2 is arranged, for example due to a low fill level, gas pockets can also arise in the liquid flow in the measurement line 30. In this case also, the suction power of the pump 18 is reduced by control on the basis of the pressure sensor 4 until the suction reduces in size.

End of the acceptance

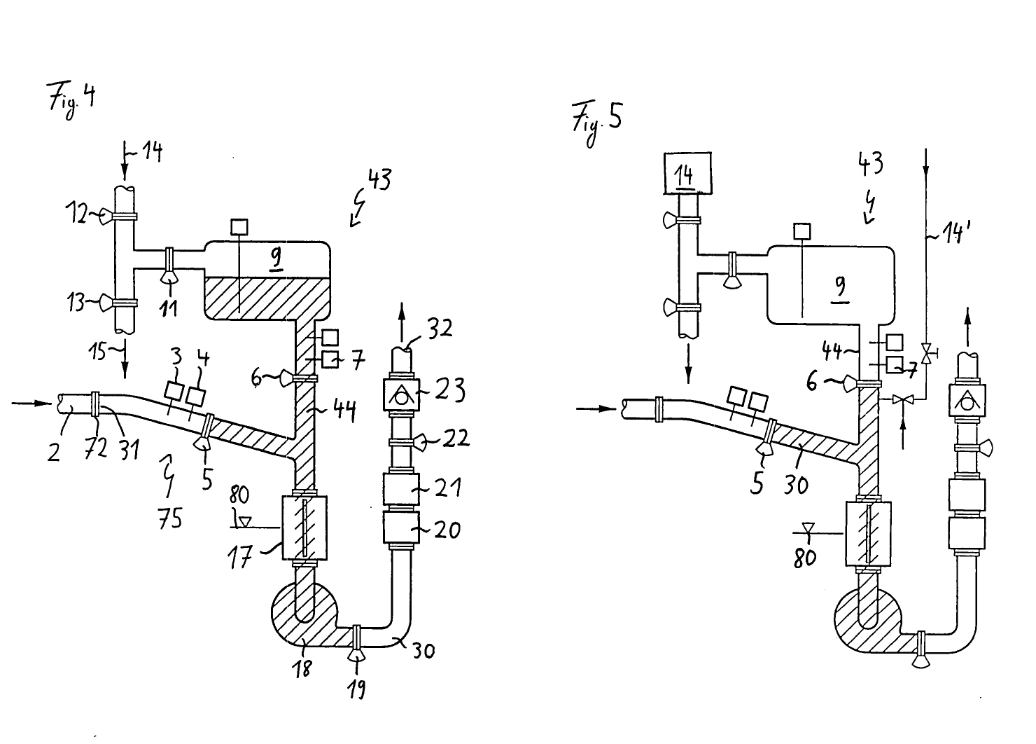

In order to explain the method process at the end of the acceptance, reference is made to FIG. 4.

At the end of the acceptance, there are large gas pockets, whereby this is initially detected on the sensor 3. If in spite of the large gas pockets, the pumping continues unchanged, there would be the risk of the underpressure in the inlet region 75 of the measurement line 30 and thus the self-suction function of the pump 18 failing. Such a status would be detected by the pressure sensor 4.

As soon therefore as large gas portions are detected by the sensor 3, possibly also by the fill level sensor 17, the pump 18 is phased down. The valve 19 is also thereby closed so that the gas entry into the measurement section which is formed by the flow measuring unit 20 and the gas portion measuring unit 21 is kept as low as possible. The shut-off valve 19 can also be included for the measurement section.

Subsequently or simultaneously, the shut-off valve 6 is opened, so that a fluid connection is produced between the intermediate storage unit 43 and the measurement line 30. On account of the underpressure present in the storage container 9 the content of the inletside line system is drawn into the storage container 9. In particular the line system in the region of the suction hose 2 can be subjected to suction until it is largely empty. In order to support the suction, the valves 11 and 13 can be opened so that a line connection exists between the storage container 9 and the unit 15 for generating an underpressure and thus the underpressure in the storage container 9 is maintained.

Through the slightly inclined position of the measurement line 30 in the region 75 behind the connection unit 72 for the suction hose 2, the liquid runs during suction into the region behind the inlet valve 5, that is to say into the region of the measurement line 30 which is on the side of the inlet valve 5 facing away from the supply opening 31. The inlet valve 5 is now closed.

In this state the residual volume is arranged in the region of the intermediate storage unit 43. Possibly contained gas portions are separated automatically over a time period and collect in the upper region of the storage container 9. Following this, the intermediate storage unit 43 can be emptied again.

For the purpose of emptying, the shut-off valve 13 is closed and the intermediate storage unit 43 is thus separated from the unit 15 for generating an underpressure. The shut-off valve 19, which separates the intermediate storage unit 43 from the outlet opening 32, is on the other hand opened. In this connection the valve 22 arranged downstream of the flow measuring unit 20 and the gas portion measuring unit 21 is switched to “reduction”, that is to say the line cross-section is reduced, in order to increase the flow resistance. In this connection, a restrictor for example can be moved into the line cross-section of the measurement line 30.

The valve 22 can be formed as a disc valve with a bore. It serves to reduce the flow speed during emptying of the intermediate storage unit 43, that is to say during the so-called “levelling”. At the same time the pressure in the region of the flow measuring unit 20 and the gas portion measuring unit 21 can be increased by means of this valve 22, whereby possibly present gas bubbles are reduced in volume so that the measurement precision can be further increased.

The non-return valve 23 can thereby prevent milk flowing back into the measurement section. At the same time this valve can also be used to increase the pressure in the measurement section.

The valve 12 is then opened and the degassed liquid, which is contained in the intermediate storage unit 43, is moved through pressure gas out of the vent unit 14 into the measurement line 30. The liquid column is conveyed until the fill level has reached the liquid sensor 7 or until the outlet level 80 is reached in the fill level sensor 17, which level can also be described as a threshold level.

Insofar as there is still residual liquid in the region of the suction hose 2, the process of suction into the intermediate storage unit 43 and feedback into the measurement line 30 can possibly be repeated several times. The suction hose 2 can hereby be cleared of residual liquid and possibly subsequently flowing liquid of the delivery tank particularly well.

If gas should penetrate the measurement section at the end of the acceptance process in spite of the degassing process in the intermediate storage unit 43, this can be detected by means of the gas portion measuring unit 21. The corresponding measurement values can be used to compensate the measurement values of the flow measuring unit 20. In addition, an excessive gas entry in the region of the gas portion measuring unit 21 can be indicated through output means.

A further embodiment of a device according to the invention is shown in FIG. 5. The embodiment of FIG. 5 differs from the previously described embodiment in that a second vent unit 14′ is provided on the intermediate storage unit 43 in the region of the storage line 44 on the side of the shut-off valve 6 facing the measurement line 30. This additional vent unit 14′ can be used to increase the speed of the process.

In particular the additional vent unit 14′ allows the shut-off valve 6 to be closed during emptying of the intermediate storage unit 43 as soon as the liquid sensor 7 arranged in the region of the shut-off valve 6 reports an empty state. Then the region of the intermediate storage unit 43 which is arranged on the side of the shut-off valve 6 facing away from the measurement line 30 and in particular includes the storage container 9 can already be emptied again, so that the intermediate storage unit 43 is ready for a new suction process, for example for residual amount suction, particularly rapidly. In order to also empty the region of the intermediate storage unit 43 which is arranged on the side of the shut-off valve 6 facing the measurement line 30, after closure of the shut-off valve 6 gas is introduced via the second vent unit 14′ into the intermediate storage unit 43 and the liquid level is hereby reduced to the level 80. The so-called “levelling” is thereby considerably simplified.

As the fill level is measured by means of the fill level sensor 17 an exact levelling to the level 80 is possible but not absolutely necessary. As the levelling takes place in a region of low cross-section which is produced by the comparatively small pipe diameter, a particularly high precision is facilitated.

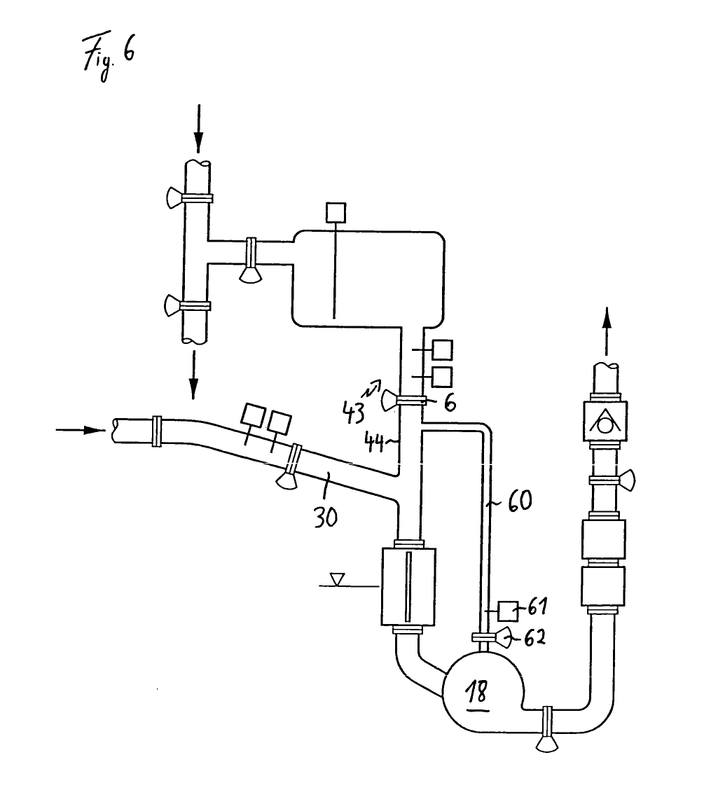

A further embodiment of the device according to the invention is shown in FIG. 6. The embodiment shown in FIG. 6 differs from the previously mentioned embodiments in that at the highest point of the pump 18 a purge line 60 formed as a pipe is arranged, which runs into the storage line 44 particularly on the side of the shut-off valve 6 facing the measurement line 30. Alternatively the purge line 60 could also run on the side of the shut-off valve 6 facing away from the measurement line 30 into the intermediate storage unit 43. The purge line 60 allows possibly arising gas collections in the upper region of the pump 18 to be removed, that is to say the pump is purposefully purged. An optionally present sensor 61 in the purge line 60 can be used to monitor the purge process. If this sensor 61 detects liquid the purge process is concluded. In this case, a valve 62 arranged on the purge line 60 between the sensor 61 and the pump 18 can be closed.

The downstream region of the measurement line 30, that is to say the region facing the outlet opening 32, is shown in detail in a perspective view in FIG. 7. As shown in FIG. 7, the measurement line 30 is formed in this region with a double U-shaped structure.

In a first vertically extending arm of the U-shaped structure, which extends vertically downwards from the branch 50 of the intermediate storage unit 43, the fill level sensor 17 and the pump 18 are arranged. In a second vertically extending arm of the U-shaped structure, the shut-off valve 19, the flow measuring unit 20 and possibly the gas portion measuring unit 21 are arranged. In a third vertically extending arm of the U-shaped structure, the valve 22 and the non-return valve 23 are arranged.

Such a double U-shaped structure is particularly advantageous having regard to degassing. In particular it allows the gas portion measuring unit 21 to be completely omitted under certain conditions.

As mentioned above, the measurement installation together with the pump 18 is phased down as soon as the fill level sensor 17 or the sensor 3 detect gas. Gas which has already penetrated the measurement line 30 escapes upwards in the double U-shaped structure and is sucked away upwards through the vacuum subsequently generated in the intermediate storage unit 43. As the liquid does not move at this time in the region of the flow measuring unit 20 as a result of the pump 18 being at rest, no liquid flow is detected either by the flow measuring unit 20 preferably formed as a magneto-inductive unit, that is to say the gas flow takes place in the liquid at rest.

If the pump 18 and the measurement system are switched off quickly enough upon entry of air, only as much gas reaches the measurement line 30 as can be degassed during the intermediate stop until the next suction via the intermediate storage unit 43 and the unit 15 for generating an underpressure until the next upward suction.

Subsequently sucked in milk can always be sucked in via the intermediate storage unit 43 and the unit 15 for generating a vacuum so that degassed milk is present, which is moved through the measurement line 30 by means of overpressure.

1-23. (canceled)

24. Method for determining an amount during the transfer of a liquid, in particular milk, comprising the steps of
introducing the liquid at a supply opening (31) into a measurement line (30) and removing the liquid from the measurement line (30) at an outlet opening (32),
determining the amount of liquid flowing through the measurement line (30) by means of a flow measuring unit (20) assigned to the measurement line (30), and
discontinuously feeding liquid present in the measurement line (30) to a degassing arrangement (40) provided for the degassing of the liquid flowing in the measurement line (30) before it reaches the flow measuring unit (20), so that the degassing arrangement is bypassed at times.

25. Method according to claim 24, wherein at least one of:
liquid present in the measurement line (30) is fed to the degassing arrangement (40) at least at the beginning and/or at the end of the transfer, and
liquid present in the measurement line (30) is fed to the degassing arrangement (40) if a previously determined value for the gas portion is exceeded.

26. Method according to claim 24, wherein:
the degassing arrangement (40) comprises an intermediate storage unit (43) which branches from the measurement line (30) between the supply opening (31) and the flow measuring unit (20), in particular in a pipeline region of the measurement line (30), and
a liquid volume is removed from the measurement line (30) between the supply opening (31) and the flow measuring unit (20) and is conveyed into the intermediate storage unit (43) for degassing, and
the liquid volume removed is then fed from the intermediate storage unit (43) between the supply opening (31) and the flow measuring unit (20) back into the measurement line (30) again.

27. Method according to claim 26, wherein, the intermediate storage unit (43) comprises a storage line (44), on which a storage container (9) is preferably provided.

28. Method according to claim 26, wherein, an underpressure is generated on the intermediate storage unit (43) for the removal of the liquid volume from the measurement line (30).

29. Method according to claim 26, wherein at least one of:
a gas is introduced into the intermediate storage unit (43) for the feedback of the liquid volume into the measurement line (30), and
a pump (18) arranged on the measurement line (30) is actuated for the feedback of the liquid volume into the measurement line (30).

30. Method according to claim 26, wherein the intermediate storage unit (43) is shut off by means of a valve (6) arranged on the intermediate storage unit (43) if the fill level in the intermediate storage unit (43) falls below a certain value when the liquid volume is fed back.

31. Method according to claim 26, wherein at least one of:
when removing the liquid volume from the measurement line (30) a fluid connection between the intermediate storage unit (43) and the flow measuring unit (20) is closed off, and
during feedback of the liquid volume into the measurement line (30) a fluid connection between the supply opening (31) and the intermediate storage unit (43) is closed off

32. Method according to claim 26, wherein, during feedback of the liquid volume into the measurement line (30) a flow cross-section of the measurement line (30) is reduced, in particular by a valve (22) arranged downstream of the flow measuring unit (20).

33. Method according to claim 24, wherein a pressure is measured in the measurement line (30) and the pump (18) arranged on the measurement line (30) is controlled in dependence upon the measured pressure.

34. Method according to claim 24, wherein:
a gas portion of the liquid present in the measurement line (30) is determined and
the measured gas portion is used to compensate measurement values of the flow measuring unit (20).

35. Method according to claim 24, wherein:
a gas portion of the liquid present in the measurement line (30) is determined and
the pump (18) arranged on the measurement line (30) is controlled in dependence upon the measured gas portion.

36. Device for determining an amount during the transfer of a liquid, for implementing the method according to claim 24, having
a measurement line (30) which comprises a supply opening (31) at one of its ends and an outlet opening (32) for the liquid at the other end, and
a flow measuring unit (20) assigned to the measurement line (30) for measuring the amount of liquid flowing through the measurement line (30), wherein:
an intermediate storage unit (43) is provided which branches from the measurement line (30) between the supply opening (31) and the flow measuring unit (20), in particular in a pipeline region of the measurement line (30), and
a unit (15) for generating an underpressure in the intermediate storage unit (43) is provided, by means of which a liquid volume can be conveyed from the measurement line (30) into the intermediate storage unit (43).

37. Device according to claim 36, wherein a vent unit (14) is provided on the intermediate storage unit (43), by means of which a gas can be introduced into the intermediate storage unit (43) for the purpose of feedback of the liquid volume from the intermediate storage unit (43) into the measurement line (30).

38. Device according to claim 36, wherein the intermediate storage unit (43) comprises a storage line (44), on which a storage container (9) is preferably provided.

39. Device according to claim 36, wherein:
a plurality of vent units (14, 14′) are arranged along the intermediate storage unit (43) and
a shutoff valve (6) is arranged on the intermediate storage unit (43) between each of the individual vent units (14, 14′).

40. Device according to claim 36, wherein at least one fill level sensor (10) is provided on the intermediate storage unit (43), in particular on the storage container (9).

41. Device according to claim 40, wherein a valve (11) is provided between the unit (15) for generating the underpressure and the intermediate storage unit (43), whereby said valve (11) can be actuated in dependence upon the fill level determined by the fill level sensor (10).

42. Device according to claim 36, wherein:
a pump (18) is provided on the measurement line (30), in particular between the branch (50) of the intermediate storage unit (43) and the outlet opening (32), and
a purge line (60) is preferably provided on the pump (18) and in particular runs into the intermediate storage unit (43).

43. Device according to claim 36, wherein the height of the measurement line (30) decreases in the region between the supply opening (31) and the intermediate storage unit (43) at least in areas towards the intermediate storage unit (43).

44. Device according to claim 36, wherein:
a tank is arranged on the measurement line (30) in the region of the outlet opening (32) and
a connection unit (72) for a suction hose (2) is arranged on the measurement line (30) in the region of the supply opening (31).

45. Device according to claim 36, wherein the measurement line (30) is formed in a U-shape, in particular a double-U-shape, on the side of the intermediate storage unit (43) facing away from the supply opening (31).

46. Device according to claim 24, wherein a control device is provided which is adapted to carry out the method according to one of the preceding claims.
